(19) United States
(12) Patent Application Publication
(10) Pub. No.: US 2014/0331486 A1
(43) Pub. Date: Nov. 13, 2014

(54) SYSTEM AND METHOD FOR NOCTURNAL RECREATIONAL ACTIVITIES

(71) Applicant: Teri Lynn Carver, Tulsa, OK (US)

(72) Inventor: Teri Lynn Carver, Tulsa, OK (US)

(21) Appl. No.: 13/890,443

(22) Filed: May 9, 2013

(51) Int. Cl. F21V 8/00

(52) U.S. Cl. CPC G02B 6/0001
USPC 29/700

(57) ABSTRACT

A system for creating recreational equipment for nocturnal use comprising: implementing a lighting system into the recreational equipment; implementing the lighting system into any field markers used with the particular activity; and engaging a field sport associate with the recreational equipment. The field sport may include baseball, football, basketball, soccer, volleyball or badminton.

### BACKGROUND OF THE INVENTION

1. Field of Invention

The present invention relates to a system that is utilized to participate in recreational activities in darkness.

2. Description of Related Art

Many times individuals participate in recreational activities such as soccer, softball, baseball, football and other activities in the outdoors. These activities normally take place during the day with the aid of sunlight. Some activities are participated at night however that requires the use of field lighting, which is not always available for some individuals. Some individuals would benefit from having a system that could provide a means to participate in these outdoor recreational activities at night without the necessity for field lighting.

### SUMMARY OF THE INVENTION

The present invention relates to a system for creating recreational equipment for nocturnal use comprising: implementing a lighting system into the recreational equipment; implementing the lighting system into any field markers used with the particular activity; and engaging a field sport associate with the recreational equipment. The field sport may include baseball, football, basketball, soccer, volleyball or badminton.

### BRIEF DESCRIPTION OF DRAWINGS

FIG. 1 depicts some exemplary embodiments of the nocturnal recreational system in accordance with the present invention.

### DETAILED DESCRIPTION

The present invention relates to a system to enable a user to participate in various recreational activities throughout the night without the aid of sunlight. Normally field games such as baseball, football, soccer or basketball all require some type of field lighting to participate in these activities at night. Therefore the present invention implements the use of lighting systems within the various components of the recreational activity to enable a fluorescent or illuminated equipment to participate in the activity during the nighttime hours.

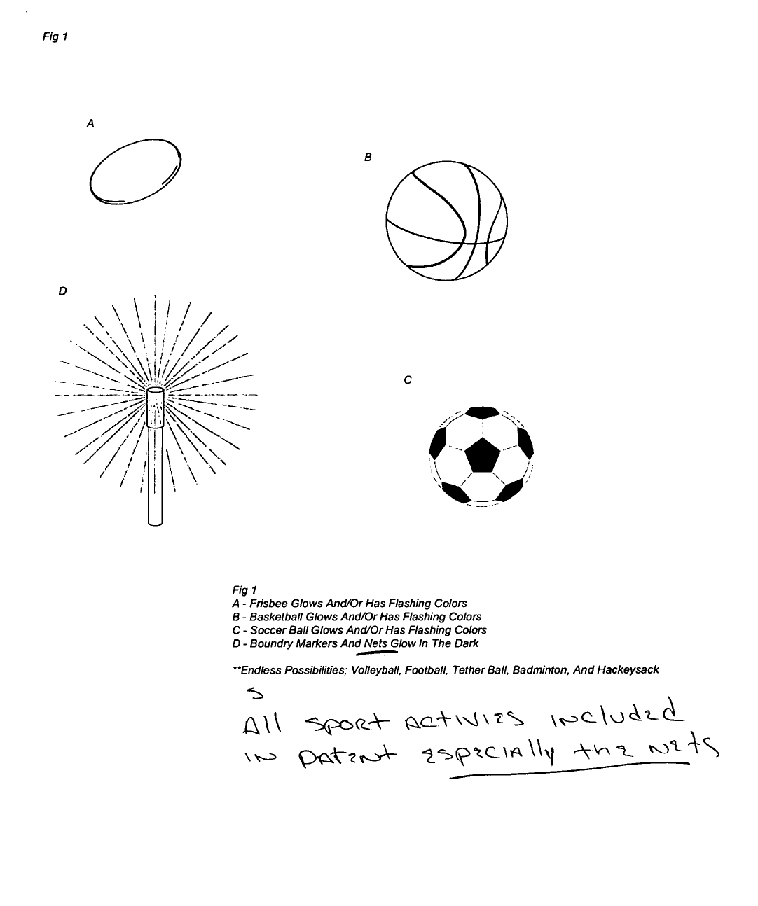

In reference to FIG. 1 various items are displayed that are associated with particular field sports. A soccer ball 40, a basketball 30, a Frisbee 20 and a field marker 10 are shown in FIG. 1. Each item is displayed as an exemplary activities that may use the present system. The system includes the implementation of lighting or fluorescent components within the balls, field markers, goals, nets or other items associated with a particular field sport. The implemented lighting and fluorescence allows the components to be visible at night. Through the use of these components users may be able to continue to participate in a traditional field activity during the evening darkness. The system may be implemented with various sports including softball, baseball, volleyball, tetherball, badminton and even placed within a Frisbee. This system allows individuals to physically see the components used during the field sport. Consequently the system may be implemented in any activity for continued play at night. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for creating recreational equipment for nocturnal use comprising:
a. implementing a lighting system into the recreational equipment;
b. implementing the lighting system into any field markers used with the particular activity; and
c. engaging a field sport associate with the recreational equipment.

2. The system according to claim 1 where the field sport includes baseball, football, basketball, soccer, volleyball and badminton.
